(19) United States
(12) Patent Application Publication
(10) Pub. No.: US 2018/0212445 A1
(43) Pub. Date: Jul. 26, 2018

(54) PORTABLE POWER SYSTEM

(71) Applicant: Damian Pitts LLC d/b/a FlexRight Solutions, Fort Washington, PA (US)

(72) Inventors: Damian D. "Skipper" Pitts, Fort Washington, PA (US); Mark Haber, Lafayette Hill, PA (US)

(73) Assignee: Damian Pitts LLC d/b/a FlexRight Solutions, Fort Washington, PA (US)

(21) Appl. No.: 15/879,016

(22) Filed: Jan. 24, 2018

Related U.S. Application Data
(60) Provisional application No. 62/449,919, filed on Jan. 24, 2017.

(51) Int. Cl. H02J 7/00; H02J 7/04

(52) U.S. Cl. CPC H02J 7/0027; H02J 7/0021; B60L 11/1811; H02J 7/04; H02J 7/0045

(57) ABSTRACT

In situations where services or operations are being conducted in the field away from infrastructure, it may be useful to have a portable power system to power drones that require battery packs and have relatively short life times. A portable power system, such as a portable drone power station, may be uniquely qualified to provide affordable remote backup power. A portable drone power station may comprise a case with at least one handle. Inside of the case there may be a plurality of lead acid batteries connected to a power inverter connected to a power supply to charge one or more drone batteries. The lead acid batteries may be monitored by a battery level indicator.

### REFERENCE TO RELATED APPLICATION

This application claims the benefit of U.S. Provisional 62/449,919 filed on Jan. 4, 2017 which is incorporated by reference as if fully set forth.

### FIELD OF INVENTION

This disclosure generally relates to portable power systems.

### BACKGROUND

In the course of providing training and services in the field, a need may arise for portable power. Specifically, drones operate on batteries with relatively short run times, and a need exists to provide power to these devices in the field.

### SUMMARY

In situations where services or operations are being conducted in the field away from traditional infrastructure, it may be useful to have a portable power system to power battery packs for drones that have relatively short life times. A portable power system, such as a portable drone power station, may be uniquely qualified to provide affordable remote backup power. A portable drone power station may comprise a rugged case with one or more handles. Inside of the case there may be a plurality of lead acid batteries connected to a power inverter connected to a power supply to charge one or more drone batteries. The lead acid batteries may be monitored by a battery level indicator.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a diagram of an example structure of a portable power system from the perspective of the top and without a lid according to one or more embodiments;

FIG. 1B is a diagram of an example structure of a portable power system from the perspective of the side according to one or more embodiments;

FIG. 1C is a diagram of an example structure of a portable power system from an isometric perspective according to one or more embodiments;

FIG. 1D is a diagram of an example structure of a portable power system from the perspective of the front according to one or more embodiments;

FIG. 1E is a diagram of an example structure of a portable power system from the perspective of the bottom according to one or more embodiments;

FIG. 1F is a diagram of an example structure of a portable power system from the perspective of the side according to one or more embodiments;

FIG. 1G is a diagram of an example structure of a portable power system from the perspective of the top with the lid on according to one or more embodiments;

FIG. 2 is a diagram of an example portable power system focused on the wheels according to one or more embodiments;

FIG. 3 is a diagram of an example portable power system focused on a front latch and locking point according to one or more embodiments;

FIG. 4 is a diagram of an example portable power system according to one or more embodiments;

FIG. 5 is a diagram of an example structure of a portable power system from the perspective of the top with an extended handle according to one or more embodiments; and

FIG. 6 is a diagram of an example portable power system according to one or more embodiments.

### DETAILED DESCRIPTION

In situations where services or operations are being conducted in the field away from infrastructure that provides power, it may be useful to have a portable power system. In one example, drones may be operated that require battery packs that have relatively short life times and may require recharging while in a remote area away from traditional power sources. A portable power system, such as a portable drone power station, may be uniquely qualified to provide affordable remote backup power. A drone, as discussed herein, may be a remote-controlled device capable of flying through the air or an unmanned aerial vehicle (UAV). A portable power system may use lead acid batteries instead of lithium polymer (LiPo) batteries to save cost. Also, a portable power system my not use solar power to avoid the added expense delicate materials.

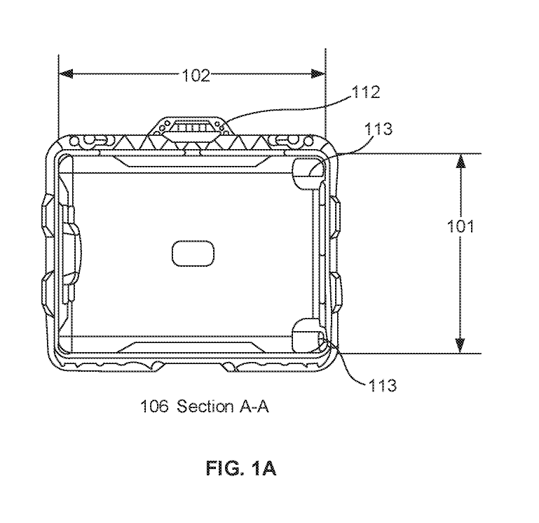

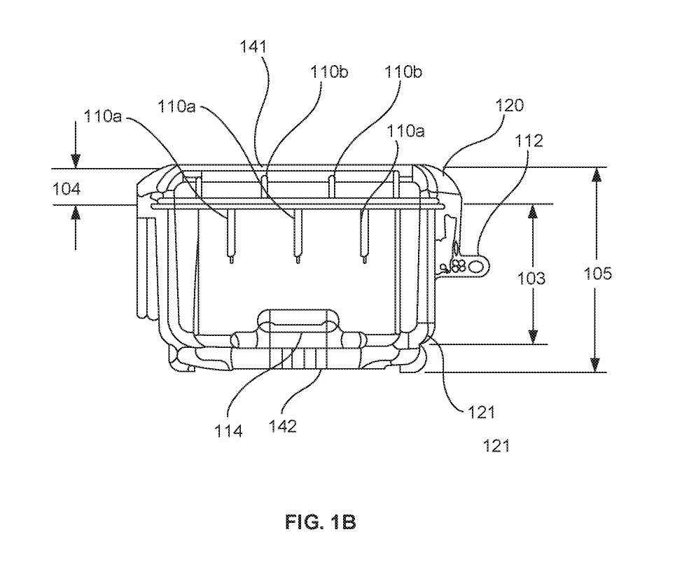

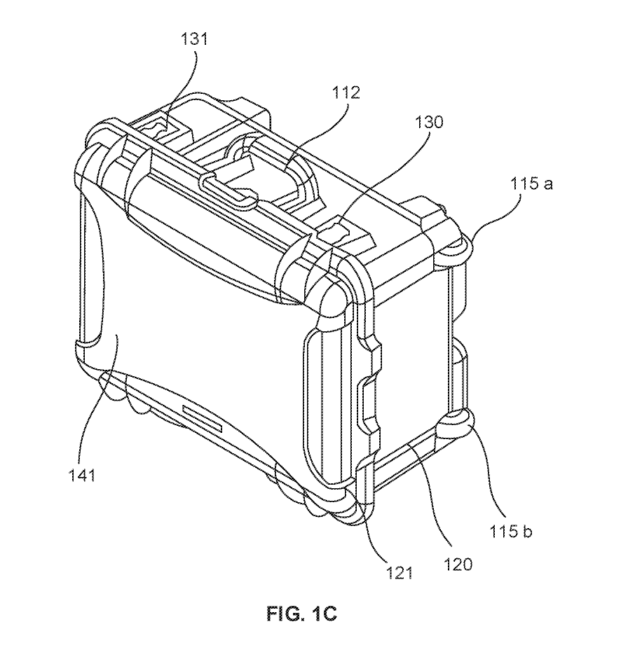

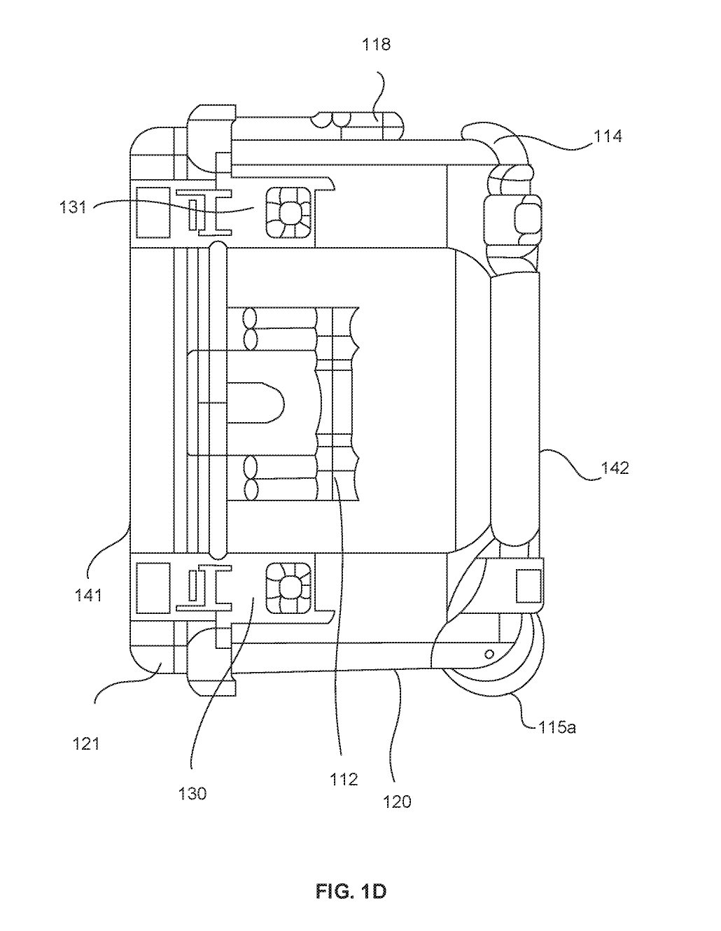

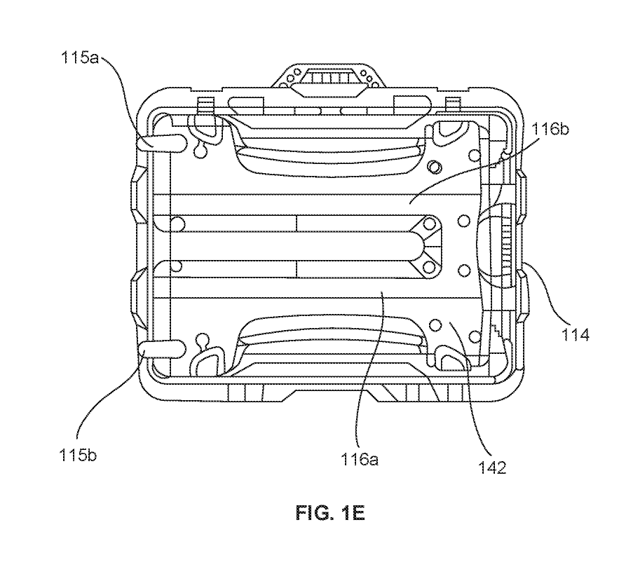

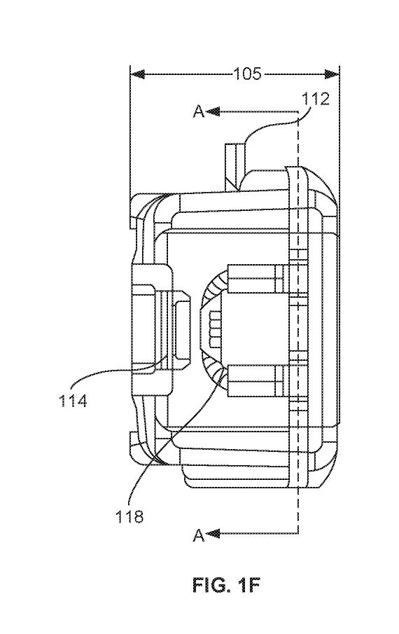

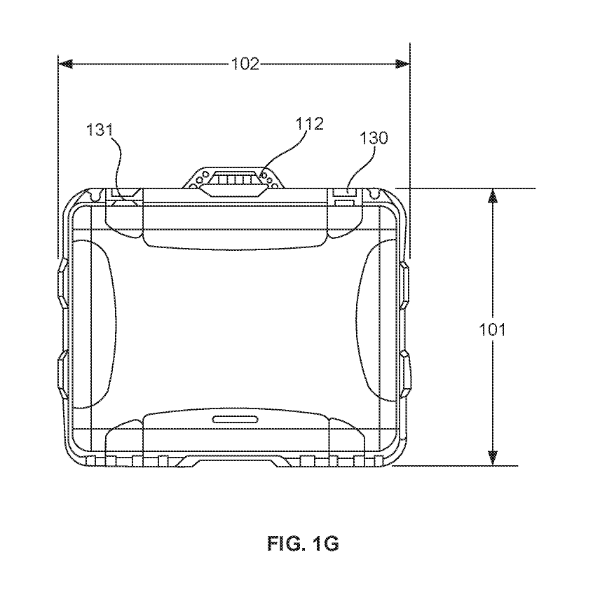

FIG. 1A is a diagram of an example structure of a portable power system from the perspective of the top and without a lid, in an open position, according to one or more embodiments. In one embodiment the portable power system may comprise a case with a handle 112 located at the front of the case. The inside of the case may have indentations 113 for wheels on the outside of the case (not shown in this figure). The case may have reinforced joints and corners to prevent damage in the event the case is handled roughly or dropped. The case may have a length 101 and a width 102. In one example, the width 102 is approximately 21 inches and the length 101 is approximately 16 inches. The lid may attach to the base with one or more hinges. Alternatively, the lid may be unattached to the base when open.

FIG. 1B is a diagram of an example structure of a portable power system from the perspective of the side according to one or more embodiments. In one embodiment the case may be reinforced with ribs 110a on the base 121 and ribs 110b on the lid 120 for structural support to handle the weight of any and all components of the portable power system. The lid 120 may have a top 141. The case may have a handle 114 that extends parallel to the width 102 of the case at the bottom 142 of the case. The base may have a height 103 and the lid may have a. height 104, which when combined comprise a case height 105. In one example the lid height 104 is approximately 2 inches, the base height 103 is 8 inches, and the case height is 10 inches.

FIG. 1C is a diagram of an example structure of a portable power system from an isometric perspective according to one or more embodiments. The case lid 120 and base 121 may seal shut enclosing the inside of the case by latching mechanisms 131 and 130 on either side of handle 112. The case may be weatherproof when closed. The case may have wheels 115a and 115b on a side opposite that of handle 114 to enable the case to be rolled by pulling handle 114.

FIG. 1D is a diagram of an example structure of a portable power system from the perspective of the front according to one or more embodiments. The case may have an additional handle 118 on the same side of the case as handle 114 in the middle of one side of the base 120.

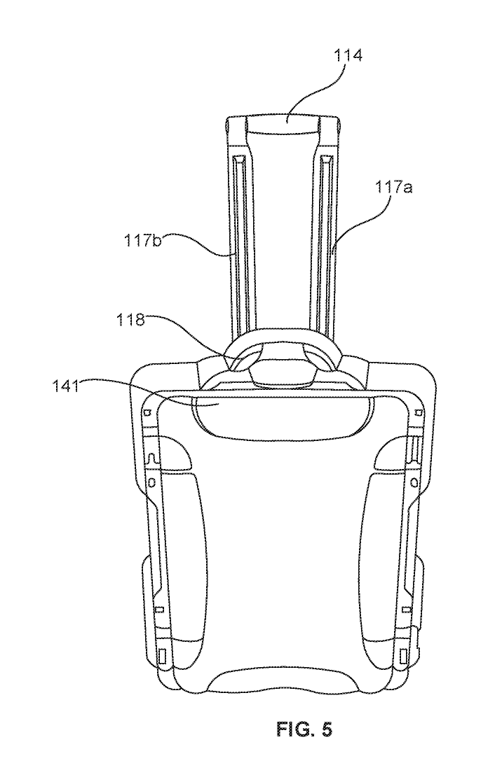

FIG. 1E is a diagram of an example structure of a portable power system from the perspective of the bottom according to one or more embodiments. The case handle 114 may have extensions 117a and 117b (shown in FIG. 5) that are enclosed in case sections 116a and 116b, respectively, on the bottom 142 of the case.

FIG. 1F is a diagram of an example structure of a portable power system from the perspective of the side according to one or more embodiments. Notations “A” indicate a cross-section perspective shown in FIG. 1A.

FIG. 1G is a diagram of an example structure of a portable power system from the perspective of the top with the lid on according to one or more embodiments.

The case may be comprised of a material suitable to meet military use specifications. For example, the case may be made of a durable high-impact resin.

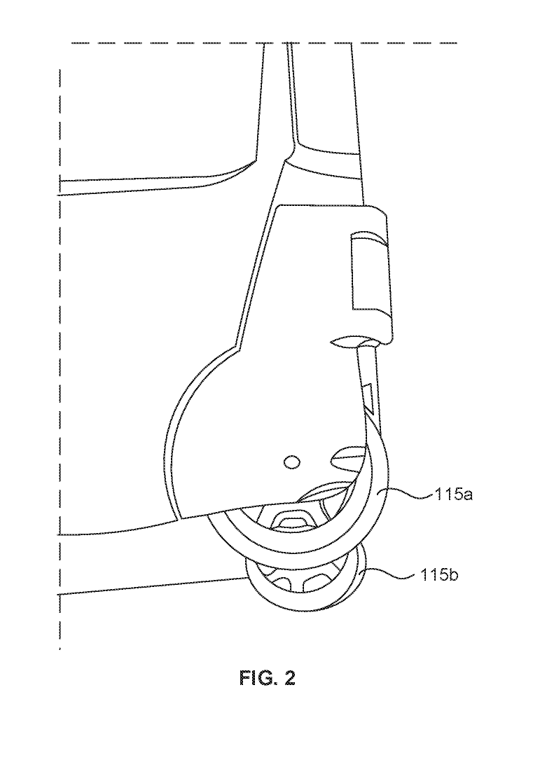

FIG. 2 is a diagram of an example portable power system focused on the wheels according to one or more embodiments.

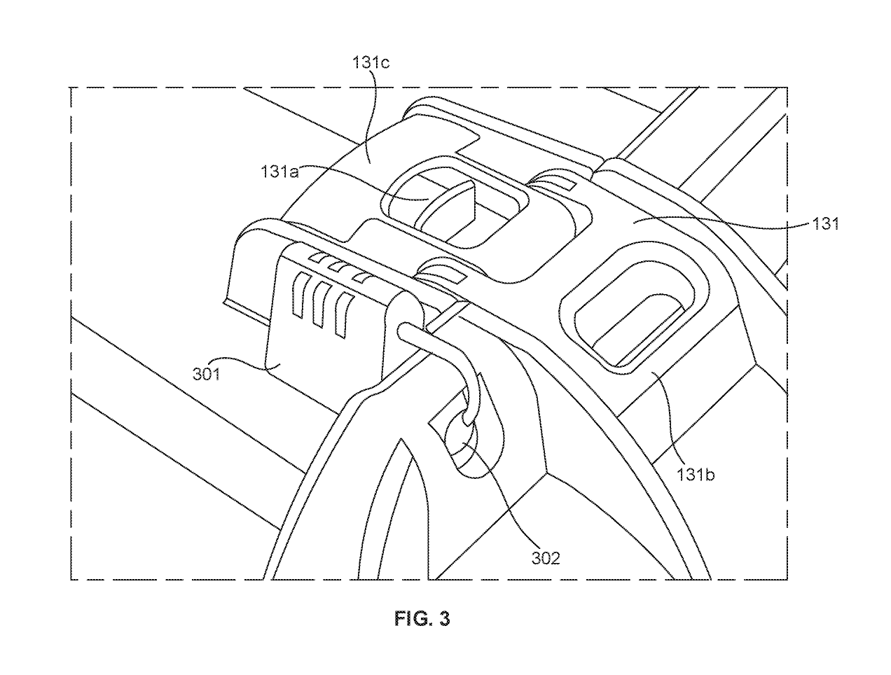

FIG. 3 is a diagram of an example portable power system focused on a. front latch and lock according to one or more embodiments. The case may be secured by a latch mechanism 131. The latch mechanism may have a top 131b that hooks into the lid 121 and is anchored to the base with the bottom of the latching mechanism 131c. The latching mechanism may require a release 131a to be pressed to unsecure the lid 121. The lid may be locked using any type of lock 301, such as a combination lock, by threading the lock through the lid and base when sealed shut through an orifice 302.

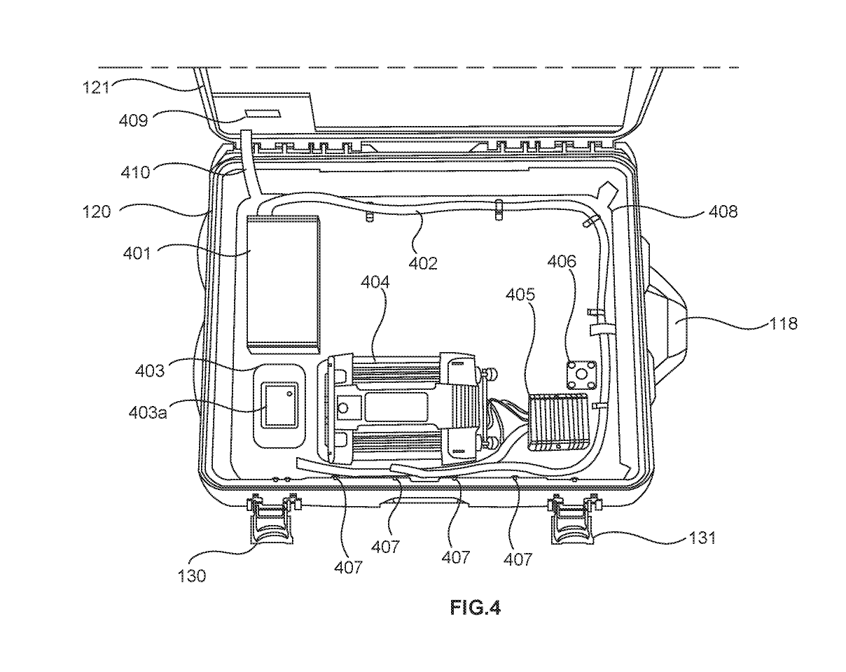

FIG. 4 is a diagram of an example portable power system according to one or more embodiments. The case may enclose one or more sealed lead acid batteries (not shown) placed in the base 120 of the case underneath separator 408. The batteries may be connected together and interfaced to the case at connector 406. In one example, there may be four batteries placed in such a manner to evenly distribute the weight of the batteries within the case. The batteries may be connected using wire, such as 12 gauge wire. There may be a battery level indicator 409 connected 410 to the lead acid batteries.

The batteries may connect to a power inverter 404. In one example, the power inverter is an 800 W power inverter for DC 12V to 110 AC with USB ports. The power inverter 404 may connect to the batteries through connector 406. The power inverter may connect to a voltage regulator 405, such as a 48V voltage regulator, which may be used to power components of the portable power system. Other components of the portable power system may include a wireless hotspot 403 with a display 403a. The wireless hotspot 403 may receive power from the voltage regulator 405 and facilitate the connections of other devices for use in the operation of the drones. The power inverter may be connected to a power supply 401, for example a 12V battery charger to charge the lead acid batteries. All cables within the portable power system may be covered with rubber tubing 402. Inside of the case there may be LED lights 407 for providing light to the case and surrounding area for use of the portable power system at night or in poorly lighted situations.

FIG. 5 is a diagram of an example structure of a portable power system from the perspective of the top with an extended handle according to one or more embodiments. The handle 114 may have extensions 117a and 117b to enable a user to pull the case while rolling on the ground.

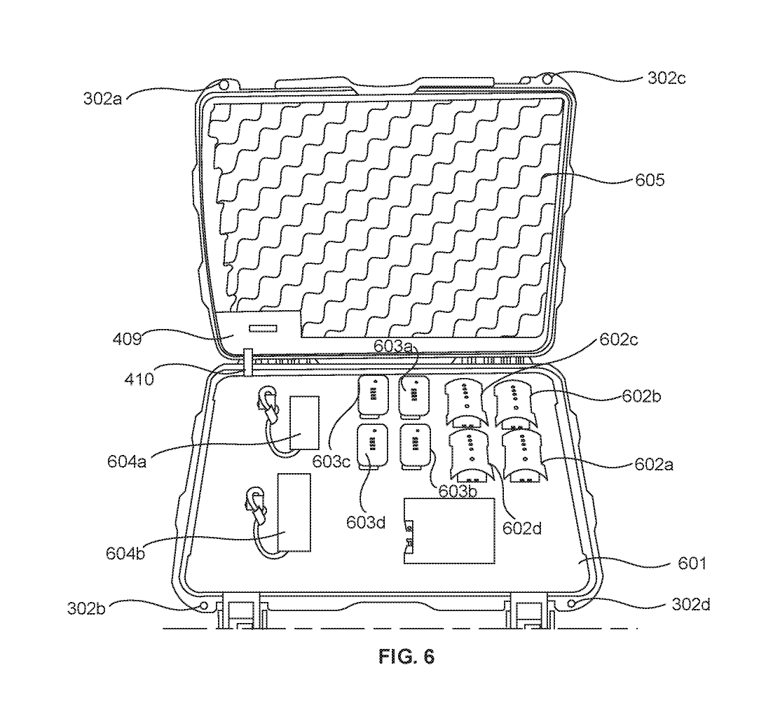

FIG. 6 is a diagram of an example portable power system according to one or more embodiments. Inside of the case there may be a foam insert 601 secure the movement of items within the case. The insert 601 may also prevent components of the portable power system from moving around during transport. The insert 601 may have cut outs specifically shaped to hold additional drone batteries (603a, 603b, 603c, 603d, 602a, 602b, 602c, 602d) and other accessories (604a, 604b) for use in the field and to be charged by the portable power system. The case may have more than one locking point, such as orifice 302a in the lid 120 that matches with orifice 302b in the base 121, as well as orifice 302c in the lid 120 that matches with orifice 302d in the base 121. Inside of the lid 121 there may be a pad 605 to provide protection to all elements within the case as well as secure all elements during transport. There may be one or more switches to operate the various components of the portable power system.

In one embodiment the portable power system may charge drone batteries while providing Wi-Fi access. In one embodiment, the case may recharge drone batteries while in the field. In one embodiment the drone batteries may be recharged while being stored in the case.

In one or more embodiments as discussed herein any element may be secured, fastened, or affixed to another element using screws, glue, nails, bolts, rivets, and the like in a manner known to one of skill in the art. In one or more embodiments as discussed herein an element connected to another element may have an electrical connection there between for control or for transfer of power.

Although features and elements are described above in particular combinations, one of ordinary skill in the art will appreciate that each feature or element can be used alone or in any combination with the other features and elements.

What is claimed is:

1. A portable drone power station, comprising:
a case with at least one handle;
a plurality of lead. acid batteries securely contained and. balanced within the case;
a power inverter operatively connected to the batteries at a level above the batteries;
a battery level indicator operatively connected to the batteries and fastened to the case;
a voltage regulator operatively connected to the power inverter;
a plurality of LED lights secured to the inside of the case operatively connected to the voltage regulator to provide light for the operation of the portable power station; and
a plurality of drone power supplies operatively connected to the power inverter and charging a plurality of drone batteries.

2. The portable power system of claim 1, wherein the case is made of a hard resin and has two wheels.

3. The portable power system of claim 2, wherein there are at least four lead acid batteries that balanced to distribute the weight evenly in the case.

4. The portable power system of claim 3, wherein the case has a lid and a base, and the battery level indicator is secured to the lid to be visible when the case is in an open position.

5. The portable power system of claim 4, wherein the lid has an orifice that matches with an orifice in the base when the lid and base are in a closed position to provide a locking point.

6. The portable power system of claim 5, further comprising a power supply operatively connected to the plurality of lead acid batteries for charging the lead acid batteries.

7. The portable power system of claim 6, further comprising a WiFi hotspot operatively connected to the voltage regulator powered by the lead acid batteries.
